(19) United States
(12) Patent Application Publication
(10) Pub. No.: US 2026/0027659 A1
(43) Pub. Date: Jan. 29, 2026

(54) Apparatus for a Welding Facility, Welding Facility and Method for Handling Disturbance Variables During Welding

(71) Applicant: Robert Bosch GmbH, Stuttgart (DE)

(72) Inventors: Juergen Haeufgloeckner, Schneeberg (DE); Maximilian Wohner, Michelstadt (DE)

(21) Appl. No.: 19/270,175

(22) Filed: Jul. 15, 2025

(30) Foreign Application Priority Data
Jul. 26, 2024 (DE) 10 2024 207 052.1

(51) Int. Cl. B23K 31/12

(52) U.S. Cl. CPC B23K 31/12

(57) ABSTRACT

An apparatus for a welding facility, a welding facility, and a method for handling disturbance variables during welding are disclosed. The apparatus has a classification device for classifying an arrangement of welding pliers as a welding tool which is present on at least one workpiece for producing at least one welded joint, and a compensation device for compensating a disturbance variable present at the arrangement of the welding pliers on the at least one workpiece.

This application claims priority under 35 U.S.C. § 119 to application no. DE 10 2024 207 052.1, filed on Jul. 26, 2024 in Germany, the disclosure of which is incorporated herein by reference in its entirety.

The present disclosure relates to an apparatus for a welding facility, a welding facility, and a method for handling disturbance variables during welding.

### BACKGROUND

In a welding facility or a welding system, at least one welding tool is generally used. In an automated welding facility, the welding tool and the welding process or welding method performed with it are controlled by a welding control system.

One of the most widely used welding methods in automated welding facilities is resistance spot welding. A welding pliers are used as the welding tool, which is supplied with an electric welding current by a welding transformer. The welding pliers can be C-shaped pliers or X-shaped pliers, each having a fixed pliers arm and a movable pliers arm. The movable pliers arm is movable relative to the fixed pliers arm, so that at least one workpiece or component to be welded can be arranged between the ends of the pliers arms. The at least one workpiece or component may comprise at least two materials or a combination of materials.

The welding control is used in resistance spot welding systems to join at least one workpiece using a predetermined clamping force and to apply the necessary welding current to the welding point for a defined time. The at least one workpiece comprises sheet metal and sheets made of different materials or materials and/or coatings.

Due to increasing demands on vehicle safety and lightweight construction, there is a constant trend toward new materials, coatings, and workpiece thicknesses, especially sheet metal thicknesses. The resulting new material thickness combinations usually have significantly lower weldability, which is accompanied by a reduction in the process window for the welding process or operation.

The resulting challenges push conventional resistance welding systems to their process limits. In this regard, further degrees of freedom had to be developed, such as the targeted monitoring and control of the welding process using the position signal and the electrode force.

The detection and compensation of production-related disturbance variables is crucial for a stable production process and consistent welding quality.

In practice, however, it is problematic that the user cannot visually monitor every weld point in production for irregularities. Such irregularities include, for example, the occurrence of a gap between the workpieces or components, the robot position relative to the workpiece, or possible edge welds.

One possible solution to this problem is to implement additional monitoring using optical/acoustic auxiliary systems. However, the accessibility of such systems is very limited and not practical in production.

Another approach would be to consider the electrode force on both electrode shafts. However, a system resulting from this has a comparatively high purchase price. Therefore, such a system is rarely used.

### SUMMARY

The present disclosure therefore provides an apparatus for a welding facility, a welding facility, and a method for handling disturbance variables during welding, with which the aforementioned problems can be solved. In particular, an apparatus for a welding facility, a welding facility and a method for handling disturbance variables during welding are to be provided, with which a predetermined welding quality can be ensured more reliably.

This task is solved by an apparatus for a welding facility set forth below. The apparatus has a classification device for classifying an arrangement of welding pliers as a welding tool, which is present on at least one workpiece for producing at least one welded joint, and a compensation device for compensating a disturbance variable present at the arrangement of the welding pliers on the at least one workpiece, wherein the classification device is designed for the classification, based on a detection result of a force sensor arranged on an arm of the welding tool, for a welded joint, whether or not a disturbance variable is present at the arrangement of the welding pliers on the at least one workpiece, wherein the classification device is designed to classify whether the disturbance variable is a gap between the at least one workpiece or is an offset between electrodes of the welding pliers on the at least one workpiece or is an edge weld or is an additional workpiece, and wherein the compensation device is designed to compensate for the disturbance variable classified by the classification device at the arrangement of the welding pliers on the at least one workpiece before and/or during the production of the welded joint to be produced.

The apparatus described provides a reliable and cost-effective way of detecting and compensating for disturbance variables before and during welding. As a result, the user obtains information about the disturbance variable present and can optimize the welding points in a targeted manner. For this purpose, the apparatus uses the detection result of a force sensor arranged on the welding pliers. The detection results of one force sensor are sufficient for the functions of the apparatus if the force sensor is arranged on the movable arm of the welding pliers. If the force sensor is arranged on the fixed arm of the welding pliers, the apparatus can additionally use detection results from a displacement sensor arranged within a motor of the welding pliers or on the movable arm of the welding pliers.

The force sensor determines the force exerted by at least one electrode on at least one workpiece before or during welding. This force is also referred to below as the “electrode force.”

In addition, the apparatus described enables the severity of the disturbance variable to be quantified. The apparatus enables the detected disturbance variables to be classified and quantified in terms of their magnitude. As a result, targeted compensation strategies can be mapped with regard to the disturbance variable. Furthermore, the apparatus is designed to automatically initiate suitable preconditioning functions.

In particular, the apparatus described can send information in real time to peripheral devices such as robots, etc. As a result, the position of the welding pliers (welding tool) relative to the at least one workpiece or component as the joining partner can be adjusted by the robot or by a pliers compensation device. This significantly improves the starting position of the welding process or operation and its quality. The apparatus thus performs suitable preconditioning functions for welding.

The advantages achievable with the apparatus improve the welding quality and reduce scrap and rework. This contributes to the conservation of resources and to cost reduction.

As a result, the apparatus can minimize the production of defective parts in a welding facility. Consequently, plant downtimes are reduced and/or shortened.

An additional advantage of the apparatus described is that a significant reduction in the time required to start up production systems, in particular production lines, can be achieved. The reason for this is that an existing disturbance variable is visualized for the user.

Further advantageous embodiments of the apparatus are also specified below. It is conceivable that the compensation device is designed to instruct an apparatus for moving the welding tool to compensate for the disturbance variable classified by the classification device, to change the arrangement of the welding tool on the at least one workpiece before and/or during the production of the welded joint to be produced, and/or wherein the classification device is also designed to classify for the welded joint to be produced that no disturbance variable is present at the arrangement of the welding pliers on the at least one workpiece before and/or during the production of the welded joint to be produced.

The classification device can also be designed to determine whether the build-up of electrode force at at least one electrode of the welding pliers for welding and the build-up of torque of a motor for moving the movable arm of the welding pliers are synchronous or asynchronous, wherein the classification device is designed to classify the existing disturbance variable as a gap or as an additional workpiece disturbance variable if the build-up of the electrode force and the torque is synchronous, and wherein the classification device is designed to classify the existing disturbance variable as an offset if the build-up of the electrode force and the torque is asynchronous.

The classification device may be designed to continuously determine the current stiffness of the welding pliers during the build-up of the electrode force at at least one electrodes of the welding pliers for welding, wherein the classification device is designed to continuously compare the determined current welding pliers stiffness with a reference pliers stiffness for the welded joint to be produced, in order to determine the compensation force required to compensate for the classified disturbance variable.

In one embodiment, the classification device is designed to classify the existing disturbance variable as a gap if the current stiffness of the welding pliers during a build-up of the electrode force at the at least one electrode of the welding pliers for welding deviates from the reference pliers stiffness and does not deviate from the reference pliers stiffness during a reduction of the electrode force at the end of the welding, wherein the classification device is designed to classify the existing disturbance variable as an offset if the current stiffness of the welding pliers deviates from the reference pliers stiffness during a build-up of the electrode force at the at least one electrode for welding and during a reduction of the electrode force at the end of the welding.

In one embodiment, the classification device is also designed to classify, after a welded joint has been produced, on the basis of the penetration depth of at least one electrode of the welding pliers into the at least one workpiece, whether or not the disturbance variable edge weld is present.

In one embodiment, the classification device is also designed to determine, for the welded joint to be produced, whether a disturbance variable is present at the arrangement of the welding pliers on the at least one workpiece, based on a detection result of the force sensor arranged on a fixed arm of the welding pliers and from a detection result of a sensor arranged on a movable arm of the welding pliers, whether or not a disturbance variable is present at the arrangement of the welding pliers on the at least one workpiece, wherein the detection result of the sensor arranged on the movable arm of the welding pliers is a position of the electrode on the movable arm relative to the at least one workpiece or is an electrode force of the electrode on the movable arm.

The classification device can also be designed to use the detection result of a displacement sensor arranged on the movable arm of the welding pliers as the detection result. Alternatively, the classification device may also be designed to use as the detection result the detection result of a sensor arranged within a motor for moving the movable arm of the welding pliers.

It is also conceivable that the apparatus described above also includes a quantification device for quantifying the magnitude of the classified disturbance variable.

The apparatus described above may be part of a welding facility for an industrial plant, wherein the welding facility also comprises a welding tool for producing at least one welded joint on at least one workpiece, a welding transformer for supplying the welding tool with a welding current for producing the welded joint, and a control device for controlling the welding transformer and the welding tool of the welding facility.

The welding facility described above also has, as an option, an operating device for outputting a message relating to a classification of the disturbance variable as an output perceptible by human senses, and/or an apparatus comprising an arm for moving the welding tool in space and a control device for controlling the arm, wherein the control device of the apparatus is subordinate to the welding control, and/or a detection device for detecting variables during the production of a welded joint with the welding tool, wherein the welding control and/or the apparatus is designed to take the detected variables into account when controlling the welding tool. The task is also solved by a method for handling disturbance variables during welding according to the description set forth below. The method is carried out with an apparatus for a welding facility, wherein the apparatus has a classification device for classifying an arrangement of welding pliers as a welding tool, which is present on at least one workpiece for producing at least one welded joint, and a compensation device for compensating a disturbance variable which is present at the arrangement of the welding pliers on the at least one workpiece, and wherein the method comprises the steps of deriving, with the classification device for a welded joint, from a detection result of a force sensor arranged on an arm of the welding tool, whether or not a disturbance variable is present at the arrangement of the welding pliers on the at least one workpiece, classifying, with the classification device, whether the disturbance variable is a gap between the at least one workpiece or an offset between electrodes of the welding pliers on the at least one workpiece or an edge weld or an additional workpiece, and compensating, with the compensation device, the disturbance variable classified by the classification device at the arrangement of the welding pliers on the at least one workpiece before and/or during the production of the welded joint to be produced.

The method achieves the same advantages previously specified with respect to the apparatus.

Further possible implementations of the disclosure also comprise combinations of features or embodiments described above or below with reference to the exemplary embodiment that are not explicitly mentioned. The person skilled in the art will also add individual aspects as improvements or additions to the respective basic form of the disclosure.

### BRIEF DESCRIPTION OF THE DRAWINGS

The disclosure is described in more detail in the following with reference to the accompanying drawing and on the basis of exemplary embodiments. The figures show:

FIG. 1 is a schematic view of an industrial plant according to a first exemplary embodiment with a welding facility that uses an apparatus for guiding welding pliers as welding tools and an apparatus for handling disturbance variables;

FIG. 2 to FIG. 7 each show an arrangement of welding electrodes of a welding tool on workpieces to be welded for illustrating possible disturbance variables during welding with the welding facility of FIG. 1, which can also be referred to as mechanical disturbance variables;

FIG. 8 shows the time profile of electrode force F and displacement/position S during force build-up for a welding operation to be carried out with the welding facility of FIG. 1 without disturbance variable and the progression of a reference curve for the stiffness of the welding tool 21 at a welding point obtained therefrom in the first exemplary embodiment from the ratio of electrode position S to the electrode force F or a target electrode force Fs;

FIG. 9 shows the time profile of electrode force F and displacement/position S during force build-up for a welding operation to be carried out with the welding facility of FIG. 1 with a gap as disturbance variable and the resulting course of the stiffness of the welding tool 21 at a welding point obtained in the first exemplary embodiment from the ratio of electrode position S to the electrode force F for compensation of the disturbance variable;

FIG. 10 shows a time profile of torque M, electrode force F and displacement/position S for a welding process in which a gap according to FIG. 5 occurs as a disturbance variable before the electrodes of the welding pliers of FIG. 1 are applied;

FIG. 11 shows a time profile of the displacement/position S and the electrode force F from force build-up to force decay in a welding process in which an offset according to FIG. 3 or FIG. 4 occurs as a disturbance variable;

FIG. 12 shows a time profile of electrode force F and displacement/position S for a welding process in which a gap according to FIG. 5 occurs as a disturbance variable during welding;

FIG. 13 is a diagram illustrating the change in electrode force F relative to the change in displacement/position S and derivation of the stiffness of the welding tool 21 at a welding point where a gap occurs as a disturbance variable during welding, as shown in FIG. 5;

FIG. 14 is a diagram illustrating the change in electrode force F relative to the change in displacement/position S for deriving the stiffness of the welding tool 21 at a welding point where a positive offset (offset+) occurs as a disturbance variable during welding, as shown in FIG. 3;

FIG. 15 shows a time profile of displacement/position S for a welding process in which no disturbance variables occur during welding, compared to a welding process in which edge weld occurs as disturbance variables during welding, as shown in FIG. 6 and FIG. 7;

FIG. 16 is a diagram illustrating the method performed by the apparatus according to the first exemplary embodiment;

FIG. 17 is a flowchart of the method performed by the apparatus according to the first exemplary embodiment;

FIG. 18 is a welding tool that can be used in an industrial plant according to a second exemplary embodiment in a welding facility;

FIG. 19 shows a welding tool that can be used in an industrial plant according to a third exemplary embodiment in a welding facility; and

FIG. 20 shows a welding tool that can be used in an industrial plant according to a fourth exemplary embodiment in a welding facility.

In the figures, the same or functionally similar elements are provided with the same reference signs unless stated otherwise.

### DETAILED DESCRIPTION

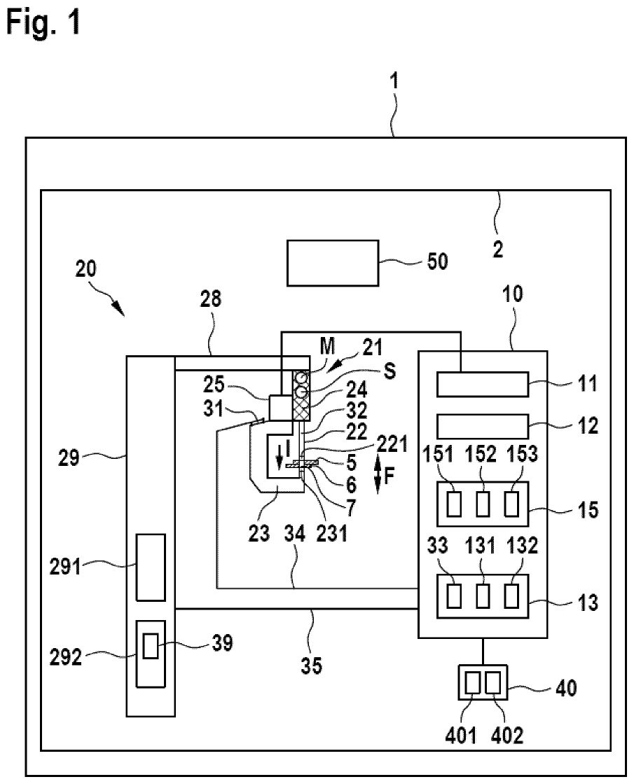

FIG. 1 shows an industrial plant 1 with a welding facility 2. The industrial plant 1 is, for example, a production line for vehicles and/or furniture and/or buildings and/or any apparatus. In the plant 1, metallic workpieces 5, 6 are joined by welding such that at least one welded joint 7 is produced. However, a welded joint 7 can only be produced on one workpiece 5 by joining two edges of the workpiece 5 with the welded joint 7. At least one workpiece 5, 6 can be a single sheet metal part. It is possible that at least one workpiece 5, 6 is already joined to another workpiece. In particular, any sheet metal joint is possible. Each of the workpieces 5, 6 may have at least one arbitrary weldable material, for example steel, aluminum, alloys thereof, etc. At least one of the workpieces 5, 6 may be coated with at least one coating. Any combinations of materials or substances are possible for the workpieces 5, 6 and for their optional at least one coating.

The welding facility 2 has a welding control 10, an apparatus 20 for guiding a welding tool 21, a detection device with sensors 31, 32, an operating device 40 and a higher-level control device 50. The higher-level control device 50 can control the welding facility 2 and/or other components of the industrial plant 1 that are not shown. Such components are, for example, a transport device for transporting in particular at least one of the workpieces 5, 6, one or more further welding facilities, one or more other tools, such as a screwdriving tool, a riveting tool, a drilling tool, a punching tool, etc.

In the present exemplary embodiment, the welding facility 2 is a resistance welding facility. In this case, the welding tool 21 is in particular a resistance welding tool. According to FIG. 1, the welding tool 21 is a pair of welding pliers, which is described in more detail below.

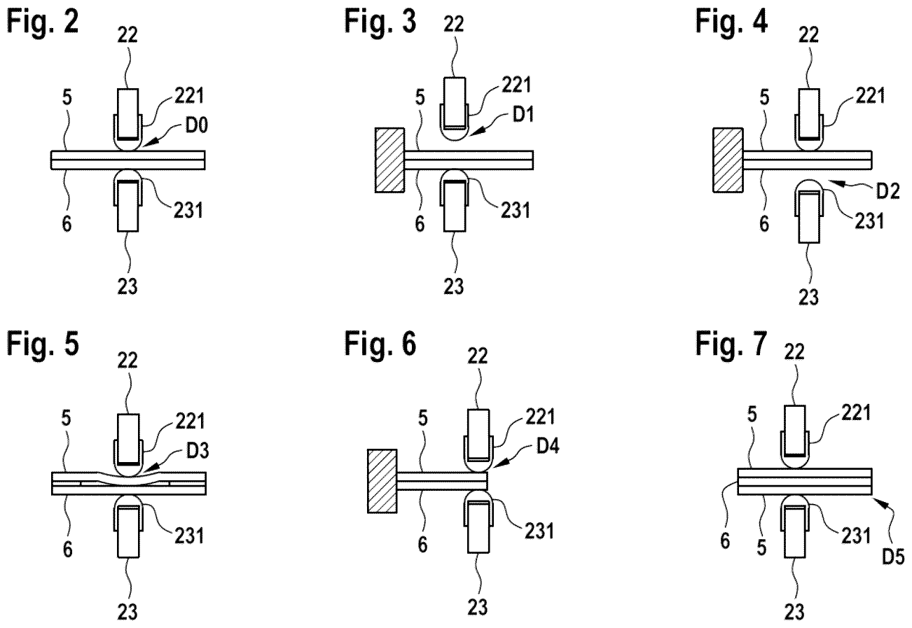

The welding control 10 has a converter device 11, a control device 12, and a memory device 13 for storing data 33, 131, 132. The welding control 10 also has an apparatus 15 for handling disturbance variables. The apparatus 15 does not necessarily have to be part of the welding control 10. The apparatus 15 can alternatively be provided externally of the welding control 10. The disturbance variables comprise a gap between the at least one workpiece 5, 6, an offset between the at least one workpiece 5, 6 and the welding tool 21, an edge weld and an additional workpiece 5, 6, as explained in more detail below based on FIGS. 2 to 7. For this purpose, the apparatus 15 of FIG. 1 has a classification device 151, a quantification device 152 and a compensation device 153, as explained in more detail below.

The apparatus 20 of FIG. 1 is, in particular, a robot. The apparatus 20 has an arm 28 and a housing 29, a control device 291 and a memory device 292. Data 39 can be stored in the memory device 292, in particular at least part of the data 131. The apparatus 20 is designed to move the welding tool 21 to a joining point on the at least one workpiece 5, 6. In addition, the apparatus 20 holds or moves the welding tool 21 at the joining point as shown in FIG. 1 in order to produce, for example, a weld spot and/or a weld seam as a welded joint 7 with the welding tool 21.

In the example shown in FIG. 1, the welding tool 21 is a pair of welding pliers with a first pliers arm 22, a second pliers arm 23, a motor 24, and a welding transformer 25 with a rectifier arranged thereon. The welding pliers shown in FIG. 1 are also referred to as a C-shaped pliers. The first pliers arm 22 is a movable pliers arm. The second pliers arm 23 is a fixed pliers arm. The first pliers arm 22 has an electrode with an electrode cap 221 at its free end. The second pliers arm 23 has an electrode with an electrode cap 231 at its free end. The electrode caps 221, 231 can be made of copper-chromium-zirconium (CuCrZr), for example. However, other materials are also possible.

A force sensor 31 for detecting a force F and a displacement sensor 32 for detecting a displacement and/or position S are provided on the welding tool 21. The sensors 31, 32 form a detection device. In the present example, the force sensor 31 is arranged on the second pliers arm 23 (fixed pliers arm). In the present example, the displacement sensor 32 is arranged on the first pliers arm 23 (movable pliers arm). Alternatively, the displacement sensor 32 is arranged in the motor 24.

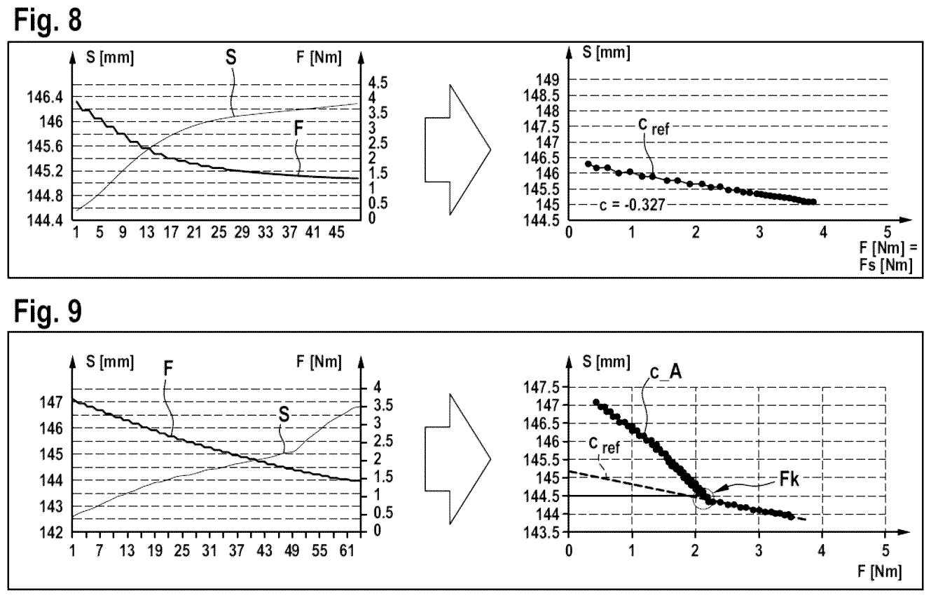

In the present example, the motor 24 is a servo motor. The motor 24 can move the movable pliers arm 22 relative to the fixed pliers arm 23, controlled by the control device 12. For this purpose, the motor 24 generates a predetermined torque M, which is converted into a longitudinal movement of the movable pliers arm 22. As a result, the electrode 22 with the electrode cap 221 moves toward the electrode 23 with the electrode cap 231 by a corresponding displacement S or away from the electrode 23 with the electrode cap 231. The displacement S traveled by the movable pliers arm 22, in particular its electrode cap 231, is detected by the displacement sensor 32. Alternatively or additionally, the actual position of the movable pliers arm 22, in particular of the motor 24, can be detected. If none of the workpieces 5, 6 are present between the electrode caps 231, 232, the electrode caps 231, 232 can rest against each other. If one of the workpieces 5, 6 is present between the electrode caps 231, 232, the electrode caps 231, 232 can be arranged against the workpieces 5, 6 as shown in FIG. 1. The force sensor 31 detects the force F acting on the fixed pliers arm 23. This is described in more detail below based on FIGS. 8 to 15.

According to FIG. 1, the following procedure is used to produce the welded joint 7. The converter device 11, controlled by the control device 12, supplies the welding transformer 24 with electrical energy in order to generate an electrical current for welding, known as the welding current I. For this purpose, the converter device 11 is supplied with electrical voltage from a three-phase voltage network. In particular, the converter device 11 is operated with a three-phase alternating current having a frequency of, for example, approximately 50 Hz and a voltage of approximately 400 V or approximately 690 V.

When guiding the welding tool 21 with an arm 28 of the apparatus 20, the apparatus 20 is controlled by its control device 29. For this purpose, the control device 29 is connected to the welding control 10 via at least one connecting line 35. Relevant data 39, 131 for performing a weld with the welding tool 21 can be exchanged between the welding control 10 and the apparatus 20, or more precisely the control device 29, via the connection line(s) 35. The data 39 are, for example, internal basic parameters or setpoints of the control device 29 and/or internal basic parameters or setpoints 131 of the welding control 10, such as a target electrode force. The control device 29 uses the parameters or setpoints to control the welding tool 21.

During operation of the welding facility 2, the detection device with the sensors 31, 32 detects detection data 33, which is transmitted via at least one connecting line 34 to the welding control 10 and stored in the memory device 13. The apparatus 15 evaluates the detection data 33. Optionally, the detection device also has a sensor for detecting the torque M of the motor 24. Alternatively, the motor current can be used as a measure of the torque M of the motor 24. Optionally, the detection device also has an acceleration sensor and/or gyro sensor. Such a sensor can also be referred to as a MEMS. The acceleration sensor and/or gyro sensor is arranged on the welding tool 21 in order to detect a rebound of the welding tool 21 on the workpiece 5, 6. In this case, it can be examined, for example, whether a pliers arm 22, 23 is already in contact with the workpiece(s) 5, 6 before a force is built up or whether a force F is detected (offset). Alternatively or additionally, it can be examined based on the signal from the acceleration sensor and/or gyro sensor whether there is a “synchronous” force build-up on the pliers arms 22, 23.

The detection data 33 is obtained by continuously detecting data from the detection device, more precisely from at least one of the sensors 31, 32. The detection can be carried out either continuously or at a predetermined sampling rate during the production of a welded joint 7. In the present exemplary embodiment, the predetermined sampling rate is selected such that an approximately continuous detection of the welding process during the production of the welded joint 7 is obtained.

The operating device 40 is, for example, a keyboard and/or a mouse, a laptop, a touch-sensitive or touch-insensitive screen, etc., or combinations thereof. The at least one operating device 40 is used in particular for commissioning or operating the welding facility 2 and for parameterizing the electrode maintenance of the welding tool 21 and for readjustment. In addition, the operating device 40 can be used to output information for a user regarding the status of the welding facility 2 and/or one of its aforementioned components. The status of the welding facility 2 comprises, among other things, at least one error message 401 about an error that may occur during operation of the welding facility 2. In addition, the detection data 33 can be displayed as an operating display 402 with the operating device 40, for example as shown in FIG. 8 to FIG. 15. Both the error message 401 and the operating display 402 are messages on the operating device 40.

The control device 12 can access the memory device 13 and store data 131, 132 in the memory device 13. Alternatively or additionally, the control device 12 can retrieve data 33, 131, 132 from the memory device 13. The control device 12 stores as data 131, for example, the operating data predefined by the control device 12, such as the electrode force F, the phase angle of the welding current I, etc., when performing a weld or producing a welded joint 7. Any other predefined operating data are conceivable.

The data 131 in the memory device 13 of FIG. 1 comprise, in addition to a reference welding sequence cref of FIG. 8 and, if applicable, the welding sequences and diagrams of FIGS. 9 to 15 and/or their characteristics, further internal basic parameters or setpoints for a welding operation with the welding tool 21, which can be entered either ex works or later by a user with the aid of the operating device 40. These additional internal basic parameters or setpoints can be parameters of the welding tool 21, in particular the maximum contact force or electrode force F of the welding tool 21 to be exerted during welding, the maximum secondary current and/or the minimum secondary current and/or the nominal secondary current I of the welding transformer 24, etc.

In or for the operation of the welding facility 2, settings required for the welding operations or welds are set on the operating device 40. During welding, the control device 12 and/or the memory device 13 receives from the detection device, more precisely at least one of the sensors 31, 32, the detection data 33 relating to welds which are carried out with the welding tool 21.

FIG. 2 shows an example of the arrangement of the pliers arms 22, 23 with the welding electrodes or electrode caps 221, 231 arranged thereon on the workpieces 5, 6. Here, both electrode caps 221, 231 are ideally positioned on the workpieces 5, 6 in order to start the welding operation for producing a welded joint 7 as shown in FIG. 1. There is therefore no disturbance variable DO. The force build-up for welding and the resulting rigidity of the welding tool 21 at a welding point is illustrated in FIG. 8 and described in more detail below.

In contrast, FIGS. 3 to 7 show arrangements of the pliers arms 22, 23 with the welding electrodes or electrode caps 221, 231 arranged thereon on the workpieces 5, 6, which are not ideal for welding.

In FIG. 3, there is a distance between the electrode cap 221 and the workpiece 5, whereas the electrode cap 231 rests against or abuts the workpiece 6. The distance is a disturbance variable D1, as shown in FIG. 3. The disturbance variable D1 is also referred to as positive offset or offset+. The offset is the spatial position of the welding tool 21 relative to the at least one workpiece 5, 6. In the example shown in FIG. 1, a positive offset or offset+ means that the fixed pliers arm 23 presses against the workpiece 6 before the force is built up. In the example of FIG. 1, a negative offset− means that there is a distance to the fixed electrode on the fixed pliers arm 23 when the force F builds up, as shown in FIG. 4.

In FIG. 4, there is a distance between the electrode cap 231 and the workpiece 6, whereas the electrode cap 221 rests against or touches the workpiece 5. The distance is a disturbance variable D2, as shown in FIG. 4. The disturbance variable D2 is also referred to as a negative offset−.

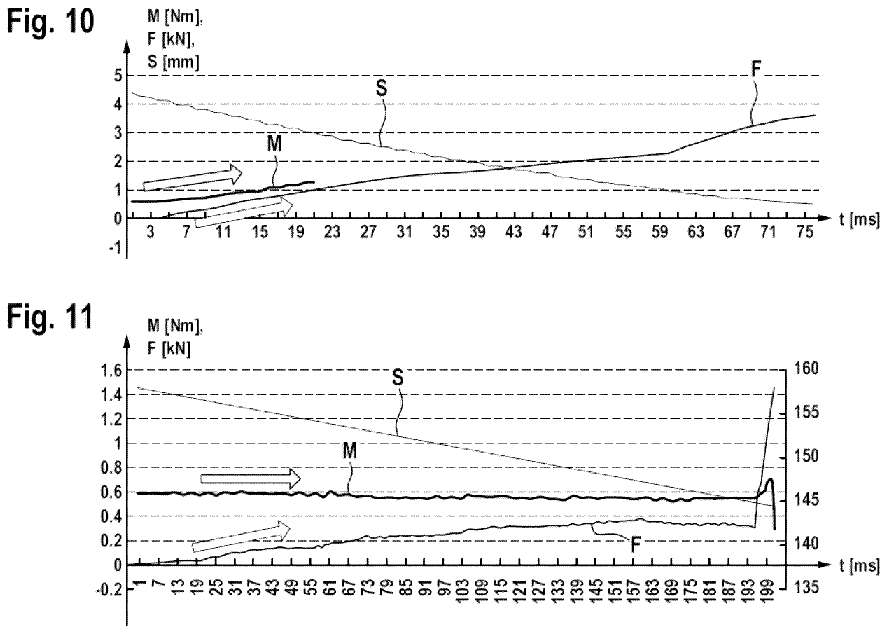

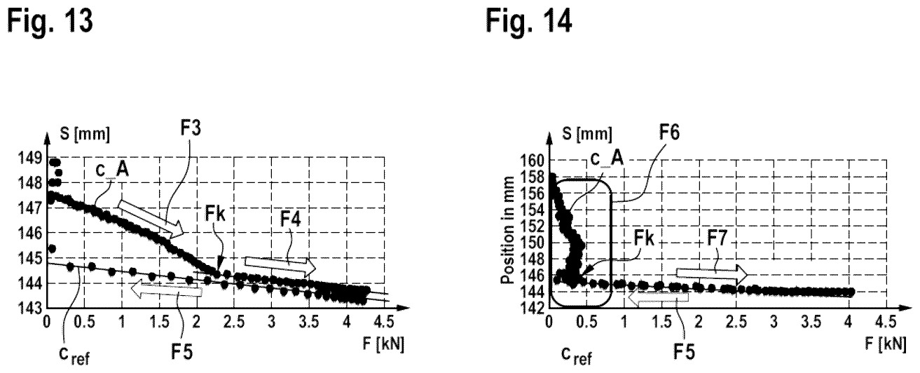

The force build-up for welding is illustrated in FIG. 1 1 with reference to the disturbance variables D1, D2 according to FIG. 3 and FIG. 4. The stiffness of the welding tool 21 resulting from the disturbance variables D1, D2 at a welding point during welding is illustrated in FIG. 14. This is described in further detail below. In FIG. 5, both electrode caps 221, 231 are in contact with the workpieces 5, 6, but there is a gap between the workpieces 5, 6. This causes the workpiece 5 to bend through to the workpiece 6. The gap is a disturbance variable D3, as shown in FIG. 5. The force build-up for or during welding and the resulting rigidity c of the welding tool 21 for welding is illustrated in FIG. 9 and FIG. 10. The stiffness of the welding tool 21 resulting from the disturbance variable D3 during welding is illustrated in FIG. 12 and FIG. 13. The disturbance variable D3 during welding is described in more detail below.

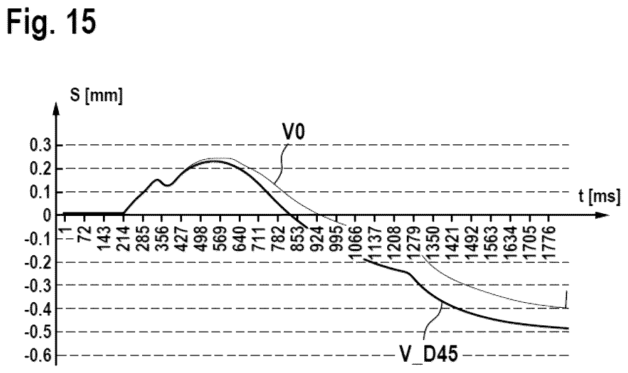

In FIG. 6, both electrode caps 221, 231 are in contact with the workpieces 5, 6. However, the electrode caps 221, 231 are attached to the edges of the workpieces 5, 6. As a result, the electrode caps 221, 231 partially protrude over the edge of the workpieces 5, 6. The edge weld is a disturbance variable D4, as shown in FIG. 6. The time profile of the position of the electrode caps 221, 231 at the edges of the workpieces 5, 6 over time during welding is illustrated in FIG. 15. This is described in further detail below.

In FIG. 7, both electrode caps 221, 231 are in contact with the workpieces 5, 6. However, an additional workpiece 5 is arranged between the electrode caps 221, 231. The electrode caps 221, 231 are therefore arranged further apart than when welding two workpieces 5, 6. The additional workpiece 5 or 6 is a disturbance variable D5, as shown in FIG. 7. The time profile of the position of the electrode caps 221, 231 over time during welding is also illustrated in FIG. 15. This is described in further detail below.

To treat the disturbance variables DI to D5 from FIG. 2 to FIG. 7, the device 15 of FIG. 1 proceeds as follows.

The apparatus 15, in particular the classification device 151, is designed to classify and quantify the different disturbance variables D1 to D5 (FIG. 3 to FIG. 7) at the current position depending on the position of the force sensor 31, at which the welding tool 21 is currently arranged for producing a welded joint 7 on the at least one workpiece 5, 6. In addition, the device 15, in particular the classification device 151, is designed to recognize that no disturbance variable D0 (FIG. 2) is present.

For this purpose, the device 15, in particular the classification device 151, uses only the two sensors 31, 32, i.e., the force sensor 31 and the displacement sensor 32, in the present exemplary embodiments.

The apparatus 15, in particular the classification device 151, is designed to use the elastic clamping properties of the welding tool 21 from FIG. 1 for disturbance quantity detection. In its simplest form, Hooke's law applies, whereby the stiffness of the welding pliers (welding tool 21) in FIG. 1 is determined by the electrode position S and electrode force F during the force build-up. The results are compared with a reference value.

The reference value is the reference pliers stiffness cref of the pliers (welding tool 21) or its progression during force build-up, as shown in FIG. 8 on the right. The device 15 determines the reference pliers stiffness cref of the gun (welding tool 21) once or several times. To determine the reference pliers stiffness cref, a welding operation is performed in which the electrodes with the electrode caps 221, 231 are in contact with each other without workpiece(s) 5, 6 (joining partners) between them.

The apparatus 15, in particular each of its devices 151, 152, 153, is designed to continuously compare the actual stiffness or actual stiffness c_A of the welding tool 21 during the build-up and decay of the force with the reference value, in particular the reference pliers stiffness cref of the pliers (welding tool 21), for each welded joint 7.

The information determined by the device 15 enables the following conclusions to be drawn:
1. Statement on the electrode force F required to compensate for the disturbance variable(s) D1 to D5.
2. Statement as to whether a gap (disturbance variable D3), an offset (disturbance variable D1 or D2), an additional workpiece 5, 6 (disturbance variable D5) or an edge weld (disturbance variable D4) is present.
3. Deriving compensation strategies prior to actual welding.
4. Adaptation of peripheral devices (device 20, clamp compensation) with regard to a correction position to compensate for the detected disturbance variable D1 to D5.

This is explained in more detail below.

The device 15 is designed to distinguish between:
a) of the disturbance variable D3 (gap) as shown in FIG. 5 and the force required to compensate for the disturbance variable D3 (gap), which is illustrated in FIG. 9,
b) the disturbance variable D1, D2 (offset+, offset−) according to FIG. 3 and FIG. 4, and between the reduced/increased electrode force F compared to a predetermined nominal force FS, which can be read from the reference pliers stiffness cref of the pliers (welding tool 21) as shown in FIG. 8 and which is stored in the data 131,
c) an edge weld and the “slipping of the electrodes”, which is previously referred to as disturbance variable D5 in relation to FIG. 5,
d) at least one additional workpiece 5, 6″, which is previously referred to as disturbance variable D4 in relation to FIG. 6, and the termination of the welding operation, and
e) the presence of no disturbance variable DO, which is shown in FIG. 2 and described above.

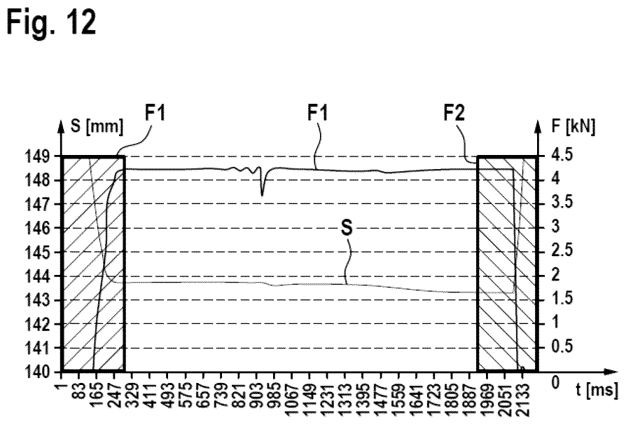

To differentiate between gap and offset, the classification device 151 generates and/or uses the current stiffness characteristic curve or reference pliers stiffness cref during the force build-up, which is shown on the right-hand side of FIG. 8. Depending on the position S of the force sensor 31, the torque M of the motor 24 can be used as the second sensor 32. During the force build-up for welding, the classification device 151 determines whether the signals of force F and torque M increase synchronously (gap), as shown in FIG. 10, or asynchronously (offset), as shown in FIG. 11. If the electrode force F increases first, there is an offset+, as shown in FIG. 3. If the torque M increases first, there is an offset−, as shown in FIG. 4. Based on the signal increase, the classification device 151 draws a conclusion about the position of the pliers (welding tool 21) in relation to the at least one workpiece 5, 6. For this purpose, the classification device 151 additionally or alternatively uses the diagrams from FIG. 12 to FIG. 15.

FIG. 12 shows the phase of force build-up F1 before welding and the phase of force reduction F2 after welding in relation to the disturbance variable D3 (gap) over the time t. As a result of the gap (disturbance variable D3), the force F in the example in FIG. 12 drops significantly for a short time at around 903 ms. In addition, the position S of the electrodes with the electrode caps 221, 231 also decreases at the time of 903 ms.

In FIG. 13, the force build-up during welding can be read off for the disturbance variable D3 (gap) from the stiffness values c shown as dots, which are plotted in relation to the position/displacement S in mm above the electrode force F in kN. The reference pliers stiffness cref is also shown in FIG. 13. An arrow F3 illustrates that the force build-up in the example in

FIG. 13 is not correct before or at the start of welding. Only after closing the gap does the force build-up become correct, as shown by arrow F4. On the other hand, the force decay after welding is OK again, as shown by the arrow F5. The device 15 recognizes from the atypical stiffness structure and the typical force decay that the disturbance variable D3 (gap) is present at the current point for producing a welded joint 7 in FIG. 1.

In FIG. 14, the force build-up during welding can be read from the dotted stiffness values (position/displacement S in mm over the electrode force F in kN) for the disturbance variable D2 (offset+). A comparison with the reference pliers stiffness cref shown in FIG. 13 shows the following. An area F6 indicates that the force build-up in the example in FIG. 13 is not correct before and after welding. Only after closing the offset/offset+ does the force build-up become correct, as shown by an arrow F7. In addition, the force decay after welding is also initially OK, as shown by arrow F3. This means that the disturbance variable D2 (offset+) can be detected both before and after welding. The device 15 recognizes from the atypical stiffness build-up and the atypical force decay that the disturbance variable D2 (offset+) is present at the current point for producing a welded joint 7 in FIG. 1.

FIG. 15 shows the position/displacement S of the electrodes with the electrode caps 221, 231 over the time t for a weld V0 without disturbance variable, as shown in FIG. 2, and in comparison a weld V_45 with the disturbance variables D4, D5. In contrast to the disturbance variable D3 (gap) and the disturbance variables D1, D2 (offset), the disturbance variable D4 (edge weld) involves a normal build-up and reduction of force. In the example in FIG. 15, the electrodes with the electrode caps 221, 231 sink deeper into the at least one workpiece 5, 6 during welding with the disturbance variables D4, D5 from a time of approximately 569 ms than during welding V0, as shown in FIG. 15. This can be detected using the workpiece thickness after the force build-up compared to the holding time. The device 15 recognizes from the deviation of the position curves and the typical force build-up and typical force decay that the disturbance variable D4 (edge weld) is present at the current point for producing a welded joint 7 in FIG. 1.

The device 15, in particular the quantification device 152, is designed to derive the force Fk of FIG. 8 or FIG. 13 or FIG. 14 from the detection results of the two sensors 31, 32, i.e., the force sensor 31 and the displacement sensor 32, which is required to compensate for the disturbance variable D1 to D5 determined by the classification device 151. FIG. 8 and FIG. 13 show examples of the force Fk in relation to the disturbance variable D3 (gap). FIG. 14 shows an example of the force Fk in relation to the disturbance variable D1 (offset+). In addition, compensation for the disturbance variables D4, D5 can be derived.

According to FIG. 8 and FIG. 9, the quantification device 152 proceeds as follows.

FIG. 8 shows on the left side a welding sequence without disturbance variable and on the right side a diagram created by the quantification device 152 to quantify a possible disturbance variable. FIG. 9 shows on the left side a welding process with the disturbance variable S3 (gap) and on the right side a diagram created by the quantification device 152 for quantifying the disturbance variable S3 (gap). For this purpose, FIG. 8 and FIG. 9 on the left-hand side show, over time t in ms, both the position of the electrodes, or more precisely their caps 221, 231, derived from the distance S in mm, and the force F in Nm at the electrodes, or more precisely their caps 221, 231. The apparatus 15, for example, the classification device 151 or the quantification device 152, performs a transformation of the detection results on the left side of FIG. 8, as shown by the block arrow in FIG. 8, to generate the diagram on the right side of FIG. 8. In the diagram on the right-hand side of FIG. 8, the position of the electrodes, or more precisely their caps 221, 231, derived from the position/displacement S in mm is plotted against the force F in Nm on the electrodes, or more precisely their caps 221, 231. The same transformation is carried out by the device 15, for example the classification device 151 or the quantification device 152, to obtain the diagram on the right-hand side of FIG. 9.

When welding workpieces 5, 6 according to FIG. 9 to FIG. 15, the quantification device 152 continuously monitors the force build-up with respect to the reference pliers stiffness cref of the welding tool 21 in order to determine the required compensation force Fk. Individual pliers stiffness values c are determined, such as c=0.327 for the diagram on the right-hand side of FIG. 8. If the quantification device 152 detects a deviation in the current stiffness value c of the welding tool 21, the quantification device 152 determines the force Fk at which the reference stiffness cref of the welding tool 21 has been reached again in the force build-up.

The mathematical relationship can be simplified using the following equation 1), which gives the minimum compensation force Fk required for a disturbance variable:

$$min [ Fk ( dF / ds = CRef ) ] \qquad 1 )$$

Here, cref is the reference pliers stiffness of the welding tool 21 and dF/ds=c_A is the current stiffness or actual stiffness including the joining partners, i.e., the at least one workpiece 5, 6. For example, each point on the upper curve in FIG. 9, FIG. 13 or FIG. 14 represents a current stiffness or actual stiffness c_A.

The quantification device 152 is also designed to compare the reference pliers stiffness cref with the actual stiffness dF/ds=c_A during force build-up in accordance with equation 1). If a match between the reference stiffness and the current stiffness is determined, i.e., cref=dF/ds=c_A, the corresponding force Fk, which is shown in the diagram on the right-hand side of FIG. 9, is entered in the log for the welding operation performed and/or the welded joint 7 created.

In addition, the device 15, in particular the quantification device 152, is designed to detect the gap height before the force build-up as redundant information of the disturbance variable D3. First, the position of the electrodes or their electrode caps 221, 231 without workpiece 5, 6 is stored after an electrode change or milling of the electrode caps 221, 231. During the force build-up, the time of the force increase and its electrode position or the position of the electrode caps 221, 231 is stored, which corresponds to the measured thickness of the at least one workpiece 5, 6 (force=0). The calculation is carried out according to the following equation 2).

$${s}_{Jointpartner} ( F = 0 ) = sist ( F = 0 ) - sref ( F = 0 ) \qquad 2 )$$

Here, S_{Jointpartner} is the thickness of workpieces 5 and 6, including any disturbance variables D1 to D5. Sref is the position of the electrode on the pliers arm 22 relative to the electrode on the pliers arm 23, more precisely from electrode cap 221 to electrode cap 231. In addition, the apparatus 15, in particular the quantification device 152, is designed to derive the stiffness of the welding pliers (arm deflection) with the aid of the reference curve cref in the diagram on the right-hand side of FIG. 8. During the holding time (nominal force Fs), the apparatus 15, in particular the quantification device 152, can estimate the material thickness of the joining partners, i.e., the workpiece thickness of the workpieces 5, 6, and determine whether the disturbance variable is completely closed or compensated.

$${s}_{Jointpartner} ( Fs ) = sist ( Fs ) - sref ( Fs ) + cref * Fmom \qquad 3 )$$

Here, Fmom is the current or instantaneous or actual force during welding.

In addition, the apparatus 15, in particular the quantification device 152, is designed to determine the total workpiece thickness after the force build-up in accordance with equation 3). Here, the instantaneous position value or the actual position is subtracted from the reference value (electrode to electrode). The elastic clamping properties are then added to the current position value or the actual position. The elastic clamping properties correspond to the arm deflection, which influences the value of the position S of the at least one workpiece 5, 6. As a result, a statement can be made about the momentary or current joining partner thickness and the compensation of a disturbance variable D1 to D5.

To compensate for at least one disturbance variable D1 to D5, the apparatus 15, in particular the compensation device 153, is designed to initiate measures such as adjusting peripheral devices such as the apparatus 20 and/or a clamp compensation. For this purpose, a correction position of peripheral devices, such as the apparatus 20 and/or a clamp compensation, can be controlled in particular.

Thus, with regard to the detected disturbance variable(s) D1 to D5, information is sent to the peripheral devices, which can change their spatial position. For example, if an “offset or edge weld” is detected, the position of the apparatus 20 can be corrected. The apparatus 20 is then moved to an improved position in order to compensate for the detected disturbance variable(s) D1 to D5.

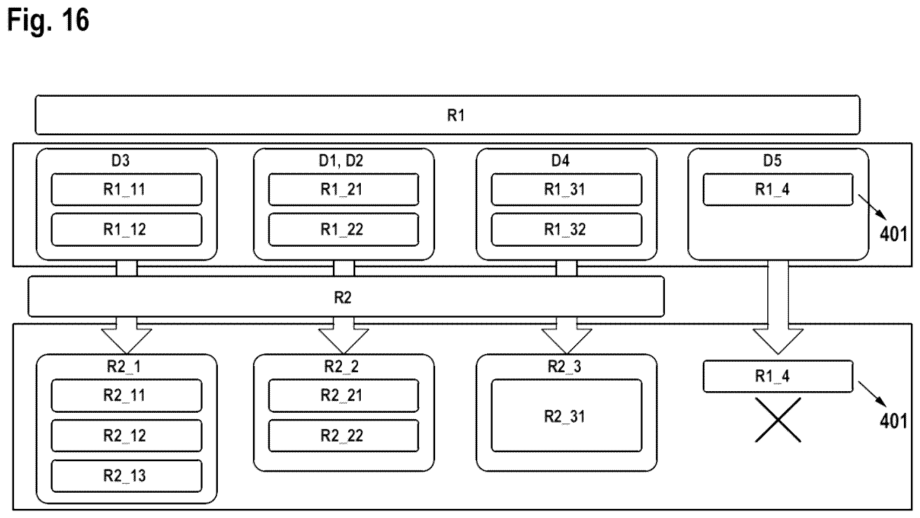

FIG. 16 provides an overview of routines R1, R2 of the method carried out by the device 15. Firstly, the device 15 performs a routine R1, in which the classification of the disturbance variables D1 to D5 is carried out with subroutines R1_11 etc. The subroutines R1_11 etc. can run at least partially simultaneously and are described in more detail below. In addition, not all subroutines R1_11 etc. need to be executed for a welded joint 7 (FIG. 1) if one of the disturbance variables D1 to D5 has already been detected. The routine R2 is executed after the routine R1 with its subroutines. Routine R2 has subroutines R2_1, etc., which are described in more detail below. Not all of the subroutines R2_1, etc. need to be performed for a welded joint 7 (FIG. 1).

As described above, the apparatus 15 analyzes the detection results of the sensors 31, 32 in order to detect and classify the disturbance variables D1 to D5 that are present at the current location for producing a welded joint 7 (FIG. 1).

To detect a gap (disturbance variable D3), apparatus 15 executes routine R1_11. Routine R1_11 determines whether compensation of the gap (disturbance variable D3) has taken place after the force has built up. The apparatus also executes routine R1_12. The routine R1_12 determines the force F required to close the gap.

To detect an offset (disturbance variables D1, D2), the apparatus 15 executes a routine R1_21. In routine R1_21, it is determined whether an asynchronous increase in torque M/force F occurs, as shown in FIG. 11 and described above. In addition, the apparatus executes a routine R1_22. In routine R1_22, the clamp rigidity c is determined before and after welding, as described above and shown in FIG. 14.

To detect edge weld (disturbance variable D4), apparatus 15 executes routine R1_31. In routine R1_31, the dip of the curve of position S during welding is determined as previously described with reference to FIG. 15. In addition, the apparatus executes routine R1_32. During routine R1_32, the penetration depth of the gap or the electrode caps 221, 231 is determined.

To detect an additional workpiece 5 (disturbance variable D5), the apparatus 15 executes a routine R1_41. In routine R1_41, the thickness of the at least one workpiece 5, 6 between the electrodes or their electrode caps 221, 231 is determined.

At least when an additional workpiece 5 (disturbance variable D5) is detected, the apparatus 15 issues a warning which can be displayed on the operating device 40 (FIG. 1), in particular as an error message 401. Optionally, the apparatus 15 can additionally or alternatively emit a warning during or after the classification of one of the disturbance variables D1 to D4, which can be displayed on the operating device 40 (FIG. 1), in particular as an error message 401.

In order to compensate for a detected gap (disturbance variable D3), the apparatus 15, in particular the compensation device 153, applies the following strategies in a routine R2_1. For this purpose, the apparatus 15 executes a subroutine R2_11 in which the electrode force K is increased by the determined amount as described above. In addition, the apparatus 15 can execute a subroutine R2_12 in which the at least one workpiece 5, 6 is preheated in order to reduce the gap stiffness. In addition, the apparatus 15 can execute a subroutine R2_13 in which the electrode force F is adaptively adjusted before and/or during welding. This allows a welded joint 7 to be produced which can be rated as “OK”.

In order to compensate for a detected offset (disturbance variables D1, D2), the apparatus 15, in particular the compensation device 153, applies the following strategies in a routine R2_2. For this purpose, the apparatus 15 executes a subroutine R2_21 in which a correction value is transferred to the apparatus 20 in order to correct the arrangement of the welding tool 21 on the at least one workpiece 5, 6 as described above. In addition, the apparatus 15 can execute a subroutine R2_22 in which the pliers compensation is corrected in order to reduce and, if possible, eliminate the offset (disturbance variables D1, D2). This allows a welded joint 7 to be produced which can be rated as “OK”.

In order to compensate for detected edge weld (disturbance variable D4), the apparatus 15, in particular the compensation device 153, applies the following strategy in a routine R2_3. For this purpose, the apparatus 15 executes a subroutine R2_31 in which a correction value is transferred to the apparatus 20 in order to correct the arrangement of the welding tool 21 on the at least one workpiece 5, 6 as described above. This allows a welded joint 7 to be produced which can be rated as “OK”.

In order to compensate for a detected additional workpiece 5 (disturbance variable D5), the apparatus 15, in particular the compensation device 153, applies the following strategy in a routine R2_4. For this purpose, the apparatus 15 executes a subroutine R2_41 in which a welding stop is initiated. This prevents a welded joint 7 from being produced which can be rated as “not OK” (NOK). In addition, the apparatus 15 issues a warning which can be displayed on the operating device 40 (FIG. 1), in particular as error message 401.

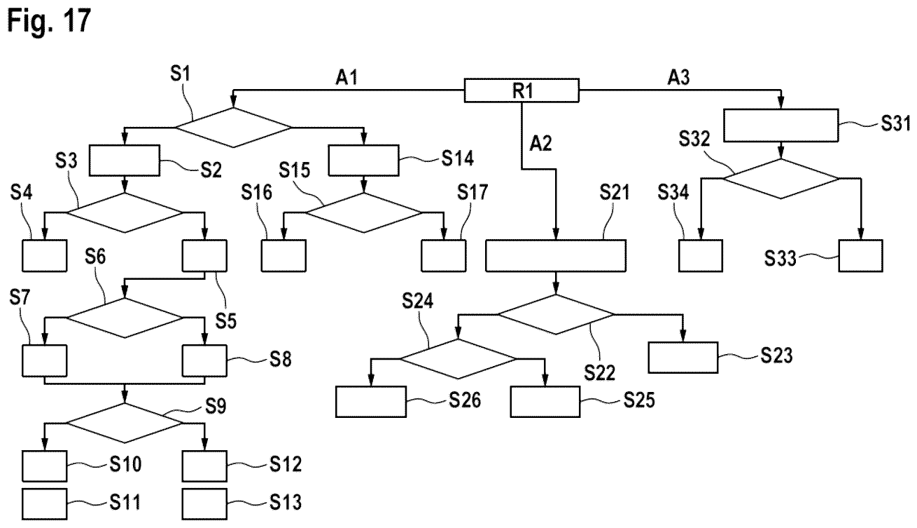

FIG. 17 illustrates the method performed by the apparatus 15 for detecting disturbance variables D1 to D5 of FIGS. 3 to 7 in a flowchart for routine R1.

The method of FIG. 16 is divided into three sequences A1, A2, and A3. The first sequence A1 takes place before welding and comprises steps S1 to S17. The second sequence A2 takes place during welding and comprises steps S21 to S26. The third sequence A3 takes place after welding and comprises steps S31 to S34.

Before welding, in step S1, when the electrodes are arranged with the caps 221, 231 of the welding tool of FIG. 1 on the at least one workpiece 5 to be welded, the increase in torque M and the increase in electrode force F are checked based on a diagram, as shown in FIG. 10 and FIG. 11 as an example. If the increase in torque M and electrode force F is synchronous, the flow proceeds to step S2. If the increase in torque M and electrode force Fis asynchronous, the flow proceeds to step S14.

In step S2, the apparatus 15, in particular its classification device 151, starts checking whether a gap, i.e., a disturbance variable D3 according to FIG. 5, is present. The flow then continues to step S3.

In step S3, the apparatus 15, in particular its classification device 151, checks whether the thickness of the at least one workpiece 5, 6 was OK before the force build-up carried out in step S1. If the thickness of the at least one workpiece 5, 6 was OK before the force build-up, the flow continues to step S4. Otherwise, the flow continues to step S5.

In step S4, the apparatus 15, in particular its classification device 151, determines that there is no gap, i.e., that there is no disturbance variable D3 according to FIG. 5. The welding operation can then be carried out, so that the apparatus 15 proceeds to the second sequence A2.

In step S5, the apparatus 15, in particular its classification device 151, determines that a gap or an additional workpiece 5 is present, i.e., that a disturbance variable D3 or D5 according to FIG. 5 or FIG. 7 is present. Therefore, the flow continues to step S6.

In step S6, the apparatus 15, in particular its classification device 151, executes subroutine R1_12 of FIG. 16 and checks whether a compensation force Fk has been determined as previously described with reference to, for example, FIG. 9, FIG. 13, and FIG. 16. If the compensation force Fk is determined, the flow proceeds to step S7. Otherwise, the flow proceeds to step S8.

In step S7, the apparatus 15, in particular its classification device 151, determines that there is a gap, i.e., that there is a disturbance variable D3 according to FIG. 5. The flow then continues to step S9.

In step S8, the apparatus 15, in particular its classification device 151, determines that an additional workpiece 5 is present, i.e., that a disturbance variable D5 according to FIG. 7 is present. After that, the flow continues to step S9.

In step S9, the apparatus 15, in particular its classification device 151, executes subroutine R1_41 of FIG. 16 and checks whether the thickness of the at least one workpiece 5, 6 was “OK” after the force build-up of step S1. If the answer is “YES,” i.e., the thickness of the at least one workpiece 5, 6 was “OK,” the flow continues to step S10. Otherwise, the flow continues to step S12.

In step S10, the apparatus 15, in particular its classification device 151, determines that the gap is now closed, i.e., that there is no longer any disturbance variable D3 according to FIG. 5. The flow then continues to step S11.

In step S11, the apparatus 15, in particular its classification device 151, determines that no disturbance variable D5 (additional workpiece 5) according to FIG. 7 is present. Thus, after step S11, the welding operation can be carried out so that the apparatus 15 proceeds to the second sequence A2.

In step S12, the apparatus 15, in particular its classification device 151, determines that the gap is not closed, i.e., that a disturbance variable D5 (additional workpiece 5) according to FIG. 7 is present. The flow then continues to step S13.

In step S13, the apparatus 15, in particular its classification device 151, determines that a disturbance variable D5 (additional workpiece 5) according to FIG. 7 is present. Thus, after step S13, the welding operation can be carried out so that the apparatus 15 proceeds to the second sequence A2.

During the welding operation according to the second sequence A2, the current pliers stiffness dF/dS=c is determined in a step S21, as previously described with reference to FIG. 9, FIG. 13 and FIG. 14. The flow then continues to step S22.

In step S22, the device 15, in particular its classification device 151, checks whether the current pliers stiffness dF/dS=c of the at least one workpiece 5, 6 was “Not OK” (NOK) or not during the force build-up during welding. If the answer is “YES,” meaning that the stiffness dF/dS =c of at least one workpiece 5, 6 was “Not OK” (NOK), the flow proceeds to step S23. Otherwise, the flow continues to step S24.

In step S23, the device 15, in particular its classification device 151, decides that neither a gap nor an offset is present, i.e., that none of the disturbance variables D1 to D3 according to FIG. 3 to FIG. 5 are present. This means that the welding operation can be carried out without compensation after step S23.

In step S24, the device 15, in particular its classification device 151, checks whether the current pliers stiffness dF/dS =c was “Not OK” (NOK) or not when the force was reduced during welding. If the answer is “YES”, i.e., the current pliers stiffness dF/dS =c was “Not OK” (NOK), the flow continues to step S25. Otherwise, the flow continues to step S26.

In step S25, the device 15, in particular its classification device 151, decides that an offset was present during welding, i.e., that one of the disturbance variables D1, D2 according to FIG. 3 or FIG. 4 was present. This information can be stored in the memory device 13. In addition, a warning and/or error message 401 can be output with the operating device 40 of FIG. 1.

In step S26, the device 15, in particular its classification device 151, decides that a gap was present during welding, i.e., that the disturbance variable D3 according to FIG. 5 was present. This information can be stored in the memory device 13. In addition, a warning and/or error message 401 can be output with the operating device 40 of FIG. 1.

After the welding operation according to the second sequence A2, sequence A3 is carried out.

In step S31, the apparatus, in particular its classification device 151 and/or quantification device 152, determines that the penetration depth of the electrodes, more precisely of their electrode caps 221, 231, is conspicuous. “Noticeable” means that the penetration depth deviates from a predetermined target value, as previously described based on FIG. 15. The flow then continues to step S32.

In step S32, the apparatus 15, in particular its classification device 151, checks whether spatter was detected during welding. A spatter or welding spatter is a loss of liquid/doughy material from the joint plane, which adheres between the at least one workpiece 5, 6 or is released into the surroundings. If at least one spatter has been detected, the flow continues to step S33. Otherwise, the flow continues to step S34.

In step S33, the device 15, in particular its classification device 151, decides that an edge weld has been performed, i.e., that a disturbance variable D4 according to FIG. 6 is present. This information can be stored in the memory device 13.

In addition, a warning and/or error message 401 can be output with the operating device 40 of FIG. 1.

In step S34, the apparatus 15, in particular its classification device 151, decides that no valid statement can be made about the presence or absence of disturbance variables D1 to D5. Thus, no valid statement can be made as to whether the welded joint 7 produced was “not OK” (NOK) or not.

Overall, the method performed by the apparatus 15 of FIG. 17 can improve the quality of the welded joints 7 that can be produced by the welding facility 2 of FIG. 1 very efficiently and cost-effectively.

The detection data 33 are monitored or evaluated by the apparatus 15 as described above. For this purpose, the apparatus 15 accesses the memory unit 13 in order to monitor or evaluate the detection data 33 in relation to the data 131, 132 stored in the memory device 13. In particular, apparatus 15 evaluates the characteristics of the welding processes and diagrams of FIGS. 9 to 15 as described above in order to check whether the welding process currently being carried out is proceeding or has proceeded as desired.

The device 15 optionally carries out the evaluation taking into account a predetermined tolerance range. The predetermined tolerance range can allow a deviation of the detection data 33 in a predetermined range from the reference pliers stiffness cref and/or the welding sequence V0 in FIG. 15.

The welding facility 2 is designed to control the welding transformer 24 and the welding tool 21 such that the operation of the welding facility 2 in the industrial plant 1 results in high-quality welded joints 7. In addition, the operator is in an even better position to recognize faults due to disturbance variables during welding due to messages, namely error messages 401 and/or operating displays 402, on the operating device 40 and is therefore able to rectify them more quickly.

According to a modification of the first exemplary embodiment, it is not only possible to signal at the operating device 40 with the error message 401 that measures are to be taken. In an advantageous embodiment, the error message 401 also comprises at least one indication of which measures are to be taken in order to maintain the operation of the welding facility 2 with as little disruption as possible or to restore it to operation as quickly as possible without disruption. Error message 401 is a visual message in particular. The visual message can use a corresponding code, such as colors or a text message in plain text, to indicate the error and/or the note. The operator is then able to take the necessary measures in good time or only after a certain tolerance phase in order to ensure that the welding facility 2 in the industrial plant 1 continues to operate for as long as possible with high-quality welded joints 7.

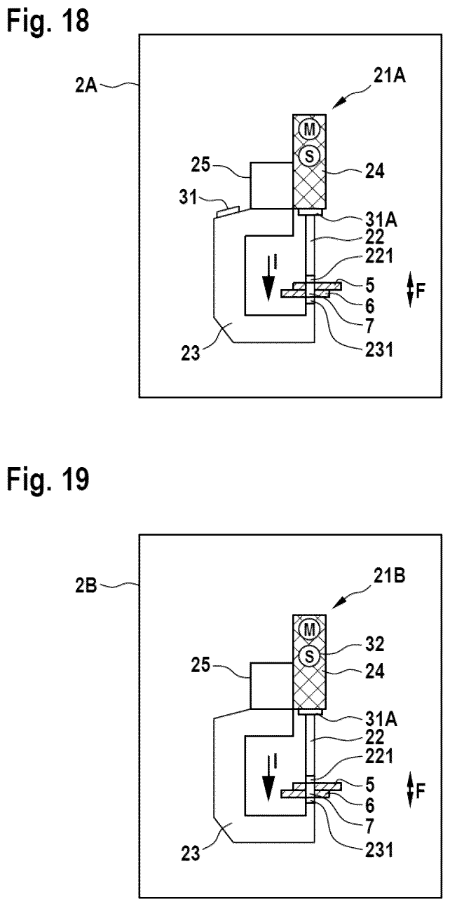

FIG. 18 shows a welding tool 21A that can be used instead of the welding tool 21 in a welding facility 2A according to a second exemplary embodiment. Like the welding tool 21 of the first exemplary embodiment, the welding tool 21A is also designed as C-shaped pliers.

In the welding tool 21A, a force sensor 31 is not only arranged on the fixed arm 23, but a force sensor 32 is also arranged on the movable arm 22.

Thus, in the present exemplary embodiment, the apparatus 15 uses the detection results of two force sensors 31, 31A to perform the treatment of the disturbance variables as described in relation to the first exemplary embodiment.

Otherwise, the welding facility 2A according to the second exemplary embodiment is constructed in the same manner as previously described for the welding facility 2 of the first exemplary embodiment, even though the other parts of the welding facility 2A are not shown in FIG. 18.

FIG. 19 shows a welding tool 21B that can be used in place of the welding tool 21 in the welding facility 2 according to a third exemplary embodiment. Like the welding tool 21 of the first exemplary embodiment, the welding tool 21A is also designed as C-shaped pliers.

In the welding tool 21A, a force sensor or displacement sensor 31A is arranged only on the movable arm 22. Thus, in the present exemplary embodiment, the apparatus 15 uses only the detection results of a sensor 31A to perform the treatment of the disturbance variables as described in relation to the first exemplary embodiment.

Since only one signal with detection results is available during welding (electrode force F or torque M of the motor 24), the apparatus 15 in the present example makes a decision between offset and gap depending on the force signal of the sensor 31A. In doing so, the apparatus compares the force build-up F1 and the force decay F2, which are shown, for example, in FIG. 12.

The apparatus 15 is designed to classify a deviating clamp stiffness characteristic curve, i.e., an atypical characteristic curve, before and after welding as disturbance variable D1 or D2, i.e., an offset according to FIG. 3 or FIG. 4, and to characterize or quantify its magnitude. In addition, the apparatus 15 is designed to distinguish between the disturbance variable D1 (offset−) of FIG. 3 and the disturbance variable D2 (offset+) of FIG. 4. For this purpose, the apparatus 15 is also designed to classify an atypical force build-up and decay before and after welding as disturbance variable D2, i.e., an offset− according to FIG. 4, and to characterize or quantify its magnitude. The disturbance variable D1, i.e., an offset+ according to FIG. 3, is not reflected in the electrode force F. Therefore, classification/characterization of the disturbance variable D1 is only partially possible in the present exemplary embodiment. For this purpose, the apparatus 15 is designed to classify a deviation of the expected arm deflection of the arms 22, 23 for welding as disturbance variable D1, i.e., an offset+ according to FIG. 3, and to characterize or quantify its magnitude. Since the fixed pliers arm 23 has already built up a force F relative to the workpiece 6, additional elastic deformation occurs before force is built up. As a result, a higher measured arm deflection/workpiece thickness is determined relative to the nominal deflection, wherein the pliers stiffness characteristic curve does not show any anomalies during force build-up.

However, the apparatus 15 is designed such that if an atypical pliers stiffness characteristic curve only appears during the force build-up (F1 in FIG. 12), this is classified as disturbance variable D3, i.e., a gap according to FIG. 5, and characterized or quantified in terms of its magnitude.

Due to the welding of at least one workpiece 5, 6, a possible gap is compensated. As a result, no noticeable behavior in the pliers stiffness is observed during opening (force decay (F2 in FIG. 12)), as shown in FIG. 12.

With regard to the treatment of disturbance variables D4 and D5, i.e., their detection, classification, characterization or quantification and compensation, the apparatus 15 operates as described with regard to the first exemplary embodiment.

In this way, too, a disturbance variable DI to D5 or the absence of a disturbance variable DO can be reliably detected, classified, characterized or quantified and compensated.

Otherwise, the welding facility 2B is constructed according to the present exemplary embodiment as described in relation to the welding facility 2 according to the first exemplary embodiment, even if the other parts of the welding facility 2B are not shown in FIG. 19.

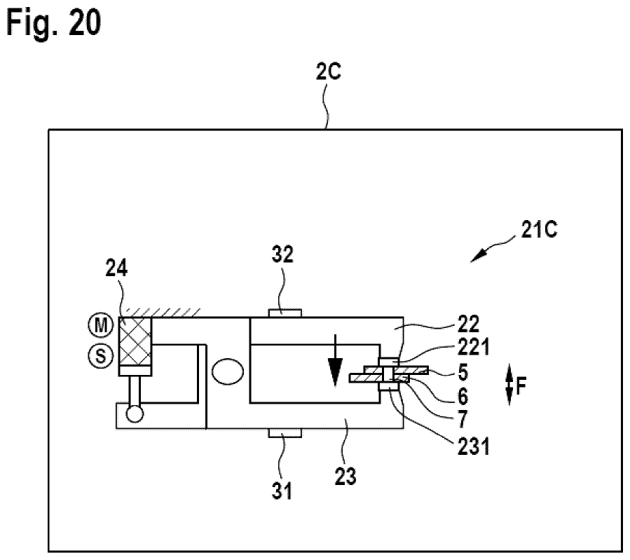

FIG. 20 shows a welding tool 21C that can be used instead of the welding tool 21 in a welding facility 2C according to a fourth exemplary embodiment. In contrast to the welding tool 21 of the first exemplary embodiment, the welding tool 21C is designed as X-shaped pliers.

In the welding tool 21C, as in the welding tool of FIG. 18, a force sensor 31 is not only arranged on the fixed arm 23, but also a force sensor 32 is arranged on the movable arm 22.

Thus, in the present exemplary embodiment, the apparatus 15 uses the detection results of two force sensors 31, 31A to perform the treatment of the disturbance variables as described in relation to the first and second exemplary embodiments.

Otherwise, the welding facility 2C according to the second exemplary embodiment is constructed in the same manner as previously described for the welding facility 2 of the first exemplary embodiment, even though the other parts of the welding facility 2C are not shown in FIG. 20.

All of the previously described embodiments of the welding facilities 2, 2A, 2B, 2C, the apparatus 15, and the previously described method can be used individually or in any combination. In particular, all features and/or functions of the previously described exemplary embodiments can be combined in any desired manner. In particular the following modifications are conceivable as well.

The parts shown in the drawings are schematic and may differ in exact design from the designs shown in the drawings as long as their previously described functions are guaranteed.

The industrial plant 1 may have a hand tool instead of the welding tool 21 guided by the apparatus 20. The apparatus 20 may alternatively be designed such that the welding tool 21 is a hand-guided tool. In addition to one of the aforementioned embodiments for the welding tool 21, 21A, 21B, 21C, it is also conceivable that the industrial plant 1 has at least one further tool, such as a screwdriving, drilling or milling tool, or a riveting tool or cutting tool or punching tool or any other tool.

The industrial plant 1 can be or have a motion logic control for, for example, transport systems or for guiding tools, etc.

What is clamed is:

1. An apparatus for a welding facility, comprising:
a classification device configured to classify an arrangement of welding pliers as a welding tool which is present on at least one workpiece for producing at least one welded joint; and
a compensation device configured to compensate a disturbance variable present at the arrangement of the welding pliers on the at least one workpiece,
wherein the classification device is designed, based on a detection result of a force sensor arranged on an arm of the welding tool for a welded joint, to derive whether a disturbance variable is present or not at the arrangement of the welding pliers on the at least one workpiece,
wherein the classification device is further designed to classify whether the disturbance variable is a gap between the at least one workpiece or an offset between electrodes of the welding pliers on the at least one workpiece or is an edge weld or is an additional workpiece, and
wherein the compensation device is arranged on the arrangement of the welding pliers on the at least one workpiece before and/or during the production of the welded joint to be produced.

2. The apparatus according to claim 1, wherein:
the compensation device is designed to instruct, in order to compensate for the disturbance variable classified by the classification device, a device configured to move the welding tool to change the arrangement of the welding tool on the at least one workpiece before and/or during production of the welded joint to be produced, and/or
the classification device is also designed to classify the welded joint to be produced such that no disturbance variable is present at the arrangement of the welding pliers on the at least one workpiece before and/or during the production of the welded joint to be produced.

3. The apparatus according to claim 1, wherein:
the classification device is designed to determine whether a build-up of the electrode force at at least one electrode of the welding pliers for welding and a build-up of a torque of a motor for moving the movable arm of the welding pliers is synchronous or asynchronous, and
the classification device is also designed to classify the existing disturbance variable as a gap or as a disturbance variable of an additional workpiece if the build-up of the electrode force and the torque is synchronous, and
the classification device is further designed to classify the existing disturbance variable as an offset if the build-up of the electrode force and the torque is asynchronous.

4. The apparatus according to claim 1, wherein:
the classification device is designed to continuously determine the current stiffness of the welding pliers during a build-up of the electrode force at at least one electrode of the welding pliers for welding, and
the classification device is designed to continuously compare the determined current welding pliers stiffness with a reference pliers stiffness for the welded joint to be produced in order to determine the compensation force required to compensate for the classified disturbance variable.

5. The apparatus according to claim 4, wherein:
the classification device is designed to classify the existing disturbance variable as a gap if the current stiffness of the welding pliers during a build-up of the electrode force at the at least one electrode of the welding pliers for welding deviates from the reference pliers stiffness and during a reduction of the electrode force at the end of the welding does not deviate from the reference pliers stiffness, and
the classification device is also designed to classify the existing disturbance variable as offset if the current stiffness of the welding pliers during a build-up of the electrode force at the at least one electrode for welding and during a reduction of the electrode force at the end of welding deviates from the reference pliers stiffness.

6. The apparatus according to claim 1, wherein the classification device is also designed, after a welded joint has been produced, to classify on the basis of the penetration depth of at least one electrode of the welding pliers into the at least one workpiece whether or not the disturbance variable edge weld is present.

7. The apparatus according to claim 1, wherein:
the classification device is also designed to determine, for the welded joint to be produced, from a detection result of the force sensor arranged on a fixed arm of the welding pliers and from a detection result of a sensor arranged on a movable arm of the welding pliers, whether or not a disturbance variable is present at the arrangement of the welding pliers on the at least one workpiece or not, and
the detection result of the sensor arranged on the movable arm of the welding pliers indicates a position of the electrode on the movable arm relative to the at least one workpiece or an electrode force of the electrode on the movable arm.

8. The apparatus according to claim 1, wherein:
the classification device is further designed to use as the detection result the detection result of a displacement sensor which is arranged on the movable arm of the welding pliers, or
the classification device is further designed to use as the detection result the detection result of a sensor which is arranged within a motor for moving the movable arm of the welding pliers.

9. The apparatus according to claim 1, further comprising a quantification device configured to quantify the magnitude of the classified disturbance variable.

10. A welding facility for an industrial plant, comprising:
a welding tool configured to produce at least one welded joint on at least one workpiece;
a welding transformer configured to supply the welding tool with a welding current for producing the welded joint;
a control device configured to control the welding transformer and the welding tool of the welding facility; and
the apparatus according to claim 1.

11. The welding facility according to claim 10, further comprising:
an operating device configured to output a message relating to a classification of the disturbance variable as an output perceptible by human senses, and/or
an apparatus which has an arm configured to move the welding tool in space and a control device configured to control the arm, wherein the control device of the apparatus is subordinate to the welding control, and/or
a detection device configured to detect variables during the production of a welded joint with the welding tool, wherein the welding control and/or the apparatus is designed to take the detected variables into account when controlling the welding tool.

12. A method for handling disturbance variables during welding, wherein the method is carried out with an apparatus for a welding facility, wherein the apparatus has a classification device configured to classify an arrangement of welding pliers as welding tools which is present on at least one workpiece for producing at least one welded joint, and a compensation device configured to compensate a disturbance variable which is present at the arrangement of the welding pliers on the at least one workpiece, and wherein the method comprises:
deriving, with the classification device for a welded joint, from a detection result of a force sensor arranged on an arm of the welding tool, whether or not a disturbance variable is present at the arrangement of the welding pliers on the at least one workpiece;
classifying, with the classification device, whether the disturbance variable is a gap between the at least one workpiece or an offset between electrodes of the welding pliers on the at least one workpiece or an edge weld or an additional workpiece; and
compensating, with the compensation device, the disturbance variable classified by the classification device at the arrangement of the welding pliers on the at least one workpiece before and/or during the production of the welded joint to be produced.
